(19) United States
(12) Patent Application Publication
(10) Pub. No.: US 2025/0100386 A1
(43) Pub. Date: Mar. 27, 2025

(54) CONNECTION CIRCUIT

(71) Applicants: Eberspächer Controls Esslingen GmbH & Co. KG, Esslingen (DE); Eberspächer Controls Landau GmbH & Co. KG, Landau (DE)

(72) Inventors: Steffen Wandres, Kandel (DE); Michael Kriessl, Göppingen (DE)

(21) Appl. No.: 18/896,425

(22) Filed: Sep. 25, 2024

(30) Foreign Application Priority Data
Sep. 25, 2023 (DE) 10 2023 125 834.6

(51) Int. Cl. B60L 1/00; B60L 3/04

(52) U.S. Cl. CPC B60L 1/00; B60L 3/04

(57) ABSTRACT

A circuit for connecting a plurality of consumers of electrical energy to a direct current source has, associated with each consumer, one connection switch each for establishing a connection between the consumer and a current source, associated with each of the consumers of the plurality of consumers, one activation circuit each for supplying a current to the consumer and for activating the associated connection switch in order to establish the connection between the respective consumer and the current source. The activation circuit includes a switching transistor. A base-emitter voltage of the switching transistor depends on the current supplied to the associated consumer via the activation circuit, and wherein, if a base-emitter voltage at a collector terminal of the switching transistor exceeds a threshold, a switch signal is generated for switching the associated connection switch into a closed state that establishes a connection between the associated consumer and current source.

### CROSS-REFERENCE TO RELATED APPLICATIONS

This application claims priority of German patent application no. 10 2023 125 834.6, filed Sep. 25, 2023, the entire content of which is incorporated herein by reference.

### TECHNICAL FIELD

The present disclosure relates to a connection circuit, via which, for example in a vehicle, a plurality of consumers of electrical energy can be connected to a direct current source.

### BACKGROUND

First and foremost in electrically propelled vehicles, there is a need, even when a vehicle is deactivated, to keep various consumers of electrical energy, such as control devices, in an activated state. In this state, such consumers of electrical energy are generally supplied with a comparatively low closed-circuit current in the range of a few 10 mA. The electronic components that maintain the connection between consumers of electrical energy and a direct current source in such a state also require electrical energy. The operating current of such electronic components is generally in the range below 100 μA.

In addition, it is necessary, even when a vehicle is deactivated, to keep system areas active that can detect the occurrence of faults, such as an overcurrent or a short circuit, and if necessary initiate measures that prevent the direct current source from draining completely and prevent the occurrence of potentially critical situations, such as a cable fire, or the like. In addition, it must also be possible to be able to operate system areas that become active autonomously, such as an engine-independent air heating system in a vehicle, even in a vehicle that is essentially deactivated, that is, to be able to supply these with electrical energy from the direct current source.

### SUMMARY

It is an object of the disclosure to provide a connection circuit for connecting a plurality of consumers of electrical energy, for example in a vehicle, to a direct current source, which connection circuit offers, when the power demand is minimized, high reliability for detecting faults.

According to the disclosure, this object is, for example, achieved by a connection circuit for connecting a plurality of consumers of electrical energy, preferably in a vehicle, to a direct current source, having:
associated with each consumer of electrical energy of a plurality of consumers of electrical energy, one connection switch each for establishing a connection between the consumer of electrical energy and a direct current source,
associated with each of the consumers of electrical energy of the plurality of consumers of electrical energy, one connection switch activation circuit each for supplying a current to the respective consumer of electrical energy and for activating the connection switch associated with the respective consumer of electrical energy in order to establish the connection between the respective consumer of electrical energy and the direct current source.

The connection switch activation circuit includes a switching transistor, wherein a base-emitter voltage of the switching transistor depends on the current supplied to the associated consumer of electrical energy via the connection switch activation circuit, and wherein, if a base-emitter voltage at a collector terminal of the switching transistor exceeds a threshold voltage, a switch signal is generated for switching the associated connection switch into a closed state that establishes a connection between the associated consumer of electrical energy and the direct current source.

In the connection circuit configured according to the disclosure, the consumers of electrical energy to be supplied via this connection circuit with electrical energy from the direct current source can essentially be supplied via the connection switch activation circuit associated therewith, in particular in order to supply these with a comparatively low closed-circuit current, for example when the vehicle is deactivated. If the closed-circuit current increases, which indicates an increased power demand, the base-emitter voltage also increases, with the result that, when a threshold current or a base-emitter voltage related thereto is reached, the emitter-collector path of the switching transistor is switched into the conducting state and, as a result, a switch signal is generated at the collector terminal of the switching transistor. This switch signal is used according to the disclosure to switch the associated connection switch into a conducting state, that is, to bring it into the closed state thereof, and, as a result, to establish a direct connection between the direct current source and the consumer of electrical energy that is triggering a higher current flow. In this state, this consumer of electrical energy is then supplied directly from the direct current source, bypassing the connection switch activation circuit, as a result of which an overloading of the connection switch activation circuit, which is essentially intended and sized only to be supplied with a comparatively low closed-circuit current, is prevented. At the same time, it can be detected on the basis of the associated connection circuit having been switched into a conducting state that a potentially critical or optionally unusual state has occurred in the region of the consumer of electrical energy interacting with this connection switch, so that further monitoring and protective measures can be implemented.

The connection switch activation circuit or each of the connection switch activation circuits associated with the various consumers of electrical energy can include a diode circuit, and the base-emitter voltage of the switching transistor is related to a voltage drop at a reference diode in the diode circuit. The voltage drop occurring at a diode generally depends on the current flowing across a diode in the forward direction. As the current flowing in the forward direction increases, the voltage drop across a diode increases. This voltage drop can be tapped and used as an indicator for the current flowing across a diode of this type.

For example, due to the parallel connection of the base-emitter path with the reference diode in the diode circuit, the base-emitter voltage can substantially correspond to a voltage drop at the reference diode. As the current flow across the reference diode increases and the forward voltage at the reference diode correspondingly increases, the base-emitter voltage also increases such that, when the threshold current is reached due to a sufficiently high base-emitter voltage, the emitter-collector path of the switching transistor is switched into the conducting state.

For a cost-effective and nevertheless reliable configuration of the connection circuit, according to the disclosure the reference diode is a p-n diode, preferably a silicon diode.

In an embodiment that is advantageous with respect to a more precise rating of the forward voltage of the reference diode in the diode circuit that brings about the connection of the switching transistor, the diode circuit can include at least one electrical resistor which is connected in series with the reference diode, and the base-emitter voltage can substantially correspond to a voltage drop at the series connection of the reference diode and at least one electrical resistor.

The reference diode here can preferably be a Schottky diode or a germanium diode. Such a diode, in comparison to a silicon diode, is distinguished by a lower threshold voltage or a minimum forward voltage at which the diode transitions into a conducting, low-impedance state. Furthermore, the resistance is lower in the conducting state.

In order, in the case of a temporarily greater increase in the current flowing across the connection switch activation circuit, to avoid overloading the reference diode, the diode circuit can include a load diode connected in parallel with the reference diode.

It is advantageous when a threshold voltage of the load diode is higher than a threshold voltage of the reference diode. It is therefore ensured that, in the normal state, that is, when a closed-circuit current is flowing, only the reference diode is in its conducting state and the voltage drop occurring at the reference diode can be tapped as base-emitter voltage. When current temporarily sharply increases, the load diode also transitions into the conducting state thereof, such that damage to the reference diode can be avoided when current increases also in the short period of time until the associated connection circuit closes.

In order, during a connection of the switching transistor of a connection switch activation circuit, to be able to use the voltage occurring at the collector terminal as a switch signal for activating the connection switch, according to the disclosure the connection switch activation circuit includes a control signal circuit, which control signal circuit is configured to generate, when a switch signal has been generated at the collector terminal of the connection switch activation circuit, a control signal to be applied at the associated connection switch for switching the connection switch into the closed state thereof.

The connection switch activation circuit preferably has an input terminal which is connected or is to be connected to the direct current source, and an output terminal which is connected or is to be connected to the associated consumer of electrical energy.

In order to be able to supply a closed-circuit current via the reference diode to the associated consumer of electrical energy and to be able to use the voltage drop occurring at the reference diode as an indicator for an increasing current, according to the disclosure the reference diode is connected in the forward direction between the input terminal and the output terminal.

According to various embodiments, an emitter terminal of the switching transistor is connected to the input terminal and/or a base terminal of the switching transistor is connected to the output terminal. Thus, there is the possibility to connect the emitter-base path of the switching transistor in parallel with the reference diode and thus to tap the voltage drop, as the emitter-base voltage, occurring at the reference diode.

In order, with a structurally simple configuration, to be able to achieve enhanced safety when potentially critical states, for example, a short circuit, occur, a safety circuit can be provided, wherein the input terminals of all connection switch activation circuits are connected or are to be connected via the safety circuit to the direct current source. The safety circuit is configured to monitor the current from the direct current source to all consumers of electrical energy of the plurality of consumers of electrical energy and, for the case in which the current exceeds a threshold current, to interrupt the connection between the direct current source and all consumers of electrical energy of the plurality of consumers of electrical energy. In a fully functional state, a current flows across the safety circuit that results due to the sum of all currents flowing across the connection switch activation circuits to the consumers of electrical energy associated therewith. For example, when the vehicle is deactivated, this therefore results, due to the sum of all closed-circuit currents conducted to the consumers of electrical energy, in a comparatively low total current that is flowing across the safety circuit. If, due to the increase in the current across one of the connection switch activation circuits, a potentially critical state is detected, the safety circuit deactivates all connection switch activation circuits and therefore protects these against overloading.

In a connection circuit configured according to the disclosure, a connection switch activation unit which is configured, for example, as a microprocessor or includes one or more microprocessor(s), can also be provided. This connection switch activation unit, when the switch signal is generated by at least one connection switch activation circuit associated with one consumer of electrical energy of the plurality of consumers of electrical energy:
deactivates all connection switch activation circuits,
   or/and
switches at least some of the connection switches, preferably all connection switches, into the closed state thereof.

Due to these measures, the connection switch activation circuits can be protected against overloading. In addition, by closing all connection switches, an energy supply system, for example in a vehicle, is switched into an active or awake state in which the various consumers of electrical energy are then connected to the direct current source via the connection switches associated therewith and monitoring measures or activation measures can be initiated or carried out in order to verify whether the present state is a potentially critical state or possibly has occurred due to the fact that a self-activating system, such as an engine-independent air heating system or an alarm system in a vehicle, has begun operating and this operation is also to be continued.

For example, the connection switch activation unit can be configured, in order to deactivate all connection switch activation circuits, to switch the safety circuit into an interrupt state interrupting the connection between the direct current source and all consumers of electrical energy of the plurality of consumers of electrical energy.

In order to achieve the switching function provided according to the disclosure in combination with a configuration that can be easily and cost-effectively implemented, the switching transistor in a connection switch activation circuit can be a bipolar transistor.

The disclosure further relates to an on-board electrical system for a vehicle, having a direct current source and consumers of electrical energy to be supplied with electrical energy from the direct current source, wherein a plurality of the consumers of electrical energy is connected or can be connected to the direct current source via a connection circuit configured according to the disclosure.

### BRIEF DESCRIPTION OF DRAWINGS

The invention will now be described with reference to the drawings wherein:

FIG. 1 shows, as a representation based on the principle, a circuit diagram of an on-board electrical system in a vehicle, which has a connection circuit;

FIG. 2 shows an embodiment of a connection switch activation circuit;

FIG. 3 shows a further embodiment of a connection switch activation circuit;

FIG. 4 shows a further embodiment of a connection switch activation circuit;

FIG. 5 shows a further embodiment of a connection switch activation circuit;

FIG. 6 shows an embodiment of a control signal circuit;

FIG. 7 shows an embodiment of a safety circuit;

FIG. 8 shows a further embodiment of a safety circuit; and,

FIG. 9 shows a further embodiment of a safety circuit.

### DETAILED DESCRIPTION

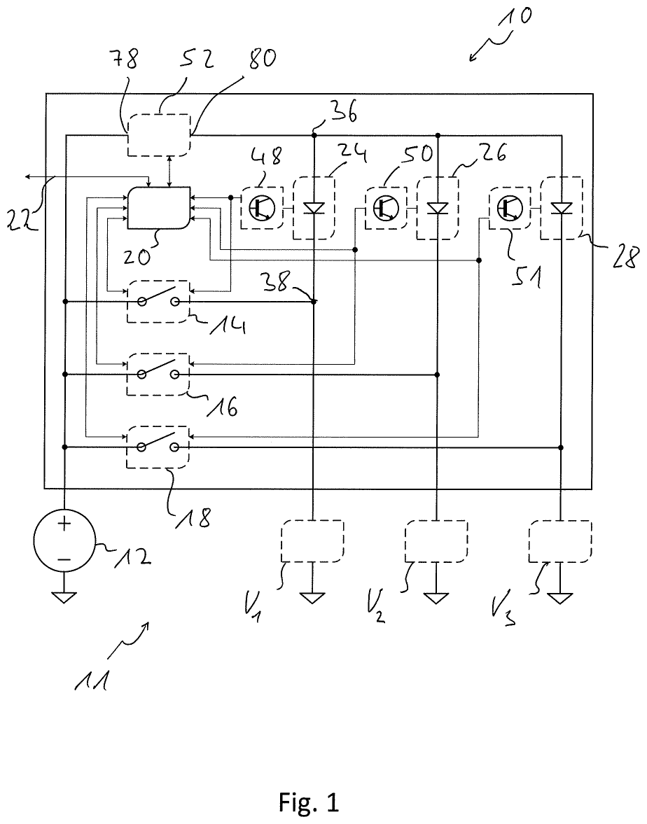

FIG. 1 shows a circuit diagram of a connection circuit, which is labeled in general with 10, in an on-board electrical system 11 of a vehicle. The connection circuit 10 can be used in a vehicle, in particular an electrically operated vehicle, for example to connect a plurality of consumers of electrical energy V₁, V₂, V₃, each of which for example includes one or more control device(s), to a direct voltage source 12, for example a battery or a low-voltage on-board electrical system, and thus to supply these with electrical energy.

The connection circuit 10 has, associated with each of the consumers V₁, V₂, V₃, one connection switch 14, 16, 18 via which a direct connection can be established between the direct current source 12 and the associated consumers V₁, V₂, V₃. The connection switches 14, 16, 18 are basically subject to the activation of a connection switch activation unit 20 which is connected, for example via a data bus 22, to a data system of a vehicle and, in this manner, according to the required operation in the vehicle, closes one or more of the connection switches 14, 16, 18 and thus establishes the connection between the direct current source 12 and the associated consumer V₁, V₂, V₃.

The connection circuit 10 also includes, associated with each of the consumers V₁, V₂, V₃ of electrical energy, a connection switch activation circuit 24, 26, 28. Via the connection switch activation circuits 24, 26, 28, the various consumers V₁, V₂, V₃ can be supplied with electrical energy, in particular in a deactivated state of a vehicle, in which the connection switch activation unit 20 can also be in a deactivated mode or a sleep mode. For example, such a consumer of electrical energy can be an alarm system of a vehicle, which must be active also when the vehicle is deactivated. A further example of such a consumer of electrical energy can be a vehicle heating device, which can be operated for example in an engine-independent air heating mode or can be brought into operation in order to preheat a vehicle interior when the vehicle is essentially deactivated.

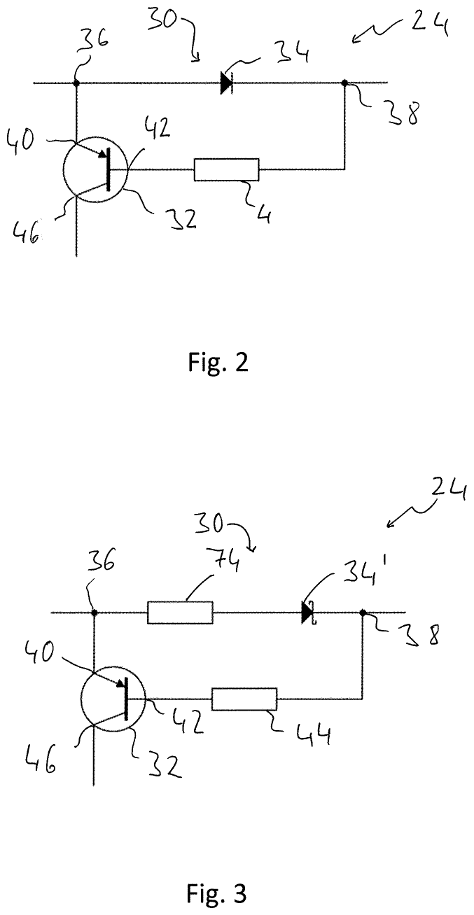

Each of the connection switch activation circuits, which are identically configured, in principle, has one diode circuit 30 and one switching transistor 32, as shown in the embodiment from FIG. 2 on the basis of the connection switch activation circuit 24. In the embodiment of the connection circuit 24 shown in FIG. 2, the diode circuit has a reference diode 34, which is in the form of a p-n diode and is connected in the forward direction between an input terminal 36 and an output terminal 38 of the connection switch activation circuit 24.

An emitter terminal 40 of the switching transistor 32, which is in the form of an NPN bipolar transistor, is connected to the input terminal 36, and a base terminal 42 of the switching transistor 32 is connected via a resistor 44 to the output terminal 38 of the connection switch activation circuit 24. A collector terminal 46 of the switching transistor 32 is connected to a control signal circuit 48 of the connection switch activation circuit 24, which control signal circuit is explained below. As is clear from FIG. 1, each connection switch activation circuit has associated therewith such a control signal circuit 48, 50 and 51 via which a control signal is generated, which control signal is emitted to the associated connection switch 14, 16, 18 and also to the control switch control unit 20.

As is also clear from FIG. 2, the base-emitter path of the switching transistor 32 is connected in parallel with the reference diode 34 in the diode circuit 30. A voltage drop that occurs in the forward direction at the reference diode 34 depending on the operation mode is therefore tapped via the base-emitter path of the switching transistor 32, and so this voltage drop substantially corresponds also to the base-emitter voltage of the switching transistor 32. When the voltage drop at the reference diode 34 is sufficiently high and, accordingly, the base-emitter voltage is sufficiently high, the switching transistor 32 switches into the conducting state thereof, and so the voltage applied at the input terminal 36 of the connection switch activation circuit 24 is applied via the switching transistor 32, which has then been switched into the conducting state, at the collector terminal 46 of the switching transistor 32 as a switch signal which has been input into the associated control signal circuit 48.

As is clear from FIG. 1, the input terminal 36 of the connection switch activation circuit 24 and, accordingly, also the input terminals of the other connection switch activation circuits 26, 28, is connected to the direct current source 12 via a safety circuit 52, which is explained below, such that, in principle, the potential forming at the positive pole of the direct current source 12 is present at all input terminals of the connection switch activation circuits 24, 26, 28 and, when the switching transistor 32 has been switched into the conducting state, is present as a switch signal at the collector terminal 46 thereof.

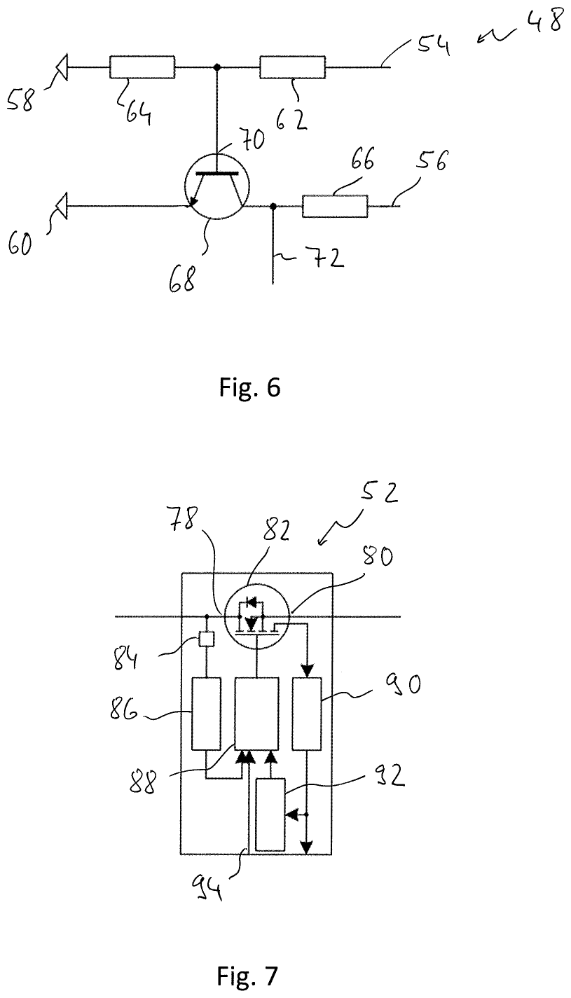

FIG. 6 illustrates, on the basis of the control signal circuit 48 associated with the connection switch activation circuit 24, an embodiment of such a control signal circuit 48. The control signal circuit 48 has two voltage terminals 54, 56 and two ground connections 58, 60. The voltage terminal 54 is connected to the collector terminal 46 of the switching transistor 32 and therefore receives the switch signal generated at the switching transistor 32 when the emitter-collector path of the switching transistor 32 has been switched into the conducting state. The voltage terminal 54 is connected to the ground connection 58 via two resistors 62, 64 connected in series. The voltage terminal 56 is connected to a reference voltage, which is generated, for example, by dividing the voltage applied at the positive pole of the direct current source 12 and can be, for example, in the range from 3.5 V to 5 V. The voltage terminal 56 is connected to the ground connection 60 via a resistor 66 and a control transistor 68, or the collector-emitter path thereof, which control transistor is in the form of a PNP bipolar transistor.

A base terminal 70 of the control transistor 68 is connected between the two resistors 62, 64 and therefore taps a voltage between these two resistors, which voltage is divided according to the ratio of these resistors, when the switch signal is applied at the voltage terminal 54. If this is the case, a voltage corresponding to the voltage drop at the resistor 64 is applied at the base-emitter path of the control transistor 68 and switches this into the conducting state. The transition between a conducting state and a non-conducting state of the collector-emitter path of the control transistor 68 results in a change in the potential generated at a control signal terminal 72, and this transition is output at the control signal terminal 72 as a control signal from the control signal circuit 48 and is applied at the associated connecting switch 14.

When the voltage drop at the reference diode 34 is sufficiently high and, therefore, the base-emitter voltage at the switching transistor 42 is correspondingly high, the switch signal applied at the voltage terminal 54 is generated at the collector terminal 46 of the switching transistor 32, which switch signal in turn switches the control transistor 68 into the conducting state and therefore results in the generation of the control signal, which is generated at the control signal terminal 72 due to a change in the voltage level. The control signal generated at the control signal terminal 72 is supplied to the connection switch 14 and switches this into the conducting state. Similarly, this control signal is supplied to the connection switch activation unit 20 and is used in the manner described below.

In the case of voltage that is applied at the input terminals of the various connection switch activation circuits 24, 26, 28 and is generated by the direct current source 12, a forward voltage is applied, in principle, at the reference diodes 34 of the various connection switch activation circuits 24, 26, 28, which forward voltage exceeds the threshold voltage of the reference diodes 34 of the connection switch activation circuits 24, 26, 28. This means that a current flow is possible across the reference diodes 34 to the respective consumers V₁, V₂, V₃ and these consumers can therefore be supplied with electrical energy in a rest state. In this rest state, only one comparatively low closed-circuit current in the range of a few 10 mA flows across each of the connection switch activation circuits 24, 26, 28. In this state, the connection switches 14, 16, 18 are in the open, non-conducting state thereof.

If an increased power demand arises at one of the consumers V₁, V₂, V₃, for example the consumer V₁, this results in a higher current flow across the connection switch activation circuit 24, or the reference diode 34 thereof, associated therewith. The result of a higher current flow across the reference diode 34 is a correspondingly elevated voltage drop at the reference diode 34. This elevated voltage drop at the reference diode 34 results in a correspondingly elevated base-emitter voltage of the switching transistor 32. When the voltage drop at the reference diode 34 is sufficiently high and, accordingly, the base-emitter voltage at the switching transistor 32 is sufficiently high, the emitter-collector path thereof is switched into the conducting state and, as a result, generates the switch signal at the collector terminal 46.

As described above, the generation of the switch signal results in the control signal, which is also supplied to the connection switch 14, being generated by the control signal circuit 48 and, as a result, the connection switch 14 is switched into the conducting state thereof. As a result of the closure of the connection switch 14 and due to the low electrical resistance thereof, practically all the electrical current supplied to the consumer V₁ is conducted across the connection switch 14. The connection switch activation circuit, or the reference diode 34 thereof, is unloaded as a result and an overloading thereof is ruled out.

Since, when the connection switch 14 is closed, the voltage drop between the input terminal 36 and the output terminal 38 of the connection switch activation circuit 24 also decreases and, accordingly, the voltage drop at the reference diode 34 and, therewith, also the base-emitter voltage at the switching transistor 32 decrease, the output of the switch signal and thus the output of the control signal is terminated. This does not result in the connection switch 14 transitioning again into the non-conducting, open state thereof, however. Since the control signal generated by the control signal circuit 48 is also supplied to the connection switch activation unit 20, the latter takes over the activation of the connection switches 14, 16, 18 and also of the safety circuit 52 at the point in time at which a control signal is supplied to the connection switch activation unit from at least one of the connection switch activation circuits 24, 26, 28, even when the vehicle is deactivated.

Due to the activation of the safety circuit 52 via the connection switch activation unit 20, the connection of the input terminals of the connection switch activation circuits 24, 26, 28 to the direct current source 12 is interrupted, regardless of whether only one signal connection switch activation circuit 24, 26, 28 has generated a switch signal, or whether a plurality of the connection switch activation circuits 24, 26, 28 has substantially simultaneously generated a switch signal and, accordingly, the associated connection switches 14, 16, and 18 have been switched into the conducting state thereof. In order to be able to simultaneously supply the various consumers V₁, V₂, V₃ with electrical energy, however, the connection switch activation unit 20 controls all connection switches 14, 16, 18 associated with the various connection switch activation circuits 24, 26, 28 such that the connection switches transition into the conducting, closed state thereof or remain in this state, if a switch signal, or a control signal, had been generated in advance.

With the above-described connection circuit, it is possible, when the vehicle is deactivated, to supply the various consumers V₁, V₂, V₃ of electrical energy with a closed-circuit current via the respective connection switch activation circuits 24, 26, 28, without the need to apply an activation voltage, which makes this supply possible, at the connection switch activation circuits 24, 26, 28. This means that no operating current flows in the individual connection switch activation circuits 24, 26, 28 and the latter enable electrical energy to be supplied to the various consumers V₁, V₂, V₃ substantially without power consumption. Only when, intentionally or optionally also due to an undefined state or a defect state, the supply of electrical energy to one or a plurality of the consumers V₁, V₂, V₃ reaches or exceeds a level that could result in damage to the connection switch activation circuits 24, 26, and 28 and/or in a discharge of the direct current source 12, is the current supplied across the connection switches 14, 16, 18 after a switching process that is carried out within a few nanoseconds. In this state, which is then guided by the connection switch activation unit 20, a check can be carried out to determine whether the higher demand in the range from one or a plurality of the consumers V₁, V₂, V₃ has arisen in conjunction with a specific operation, for example because an engine-independent air heating system has begun operating, or whether, optionally, an undefined state or a fault caused, for example, by a short circuit, exists and further safety measures are to be implemented.

FIG. 3 shows, once again on the basis of the connection switch activation circuit 24, an alternative embodiment of such a connection switch activation circuit. In this embodiment, the reference diode 34′ is in the form of a Schottky diode and is connected in series with a resistor 74 between the input terminal 36 and the output terminal 38. Such a Schottky diode 34′ is distinguished by the fact that it has a considerably lower threshold voltage than a p-n diode. Since, in the case of a Schottky diode, the voltage drop that sets in depending on the current flow is also lower than is the case with a p-n diode, in order to obtain a sufficiently high voltage drop between the input terminal 36 and the output terminal 38, it is necessary to provide this series connection of the electrical resistor 74 and the reference diode 34′.

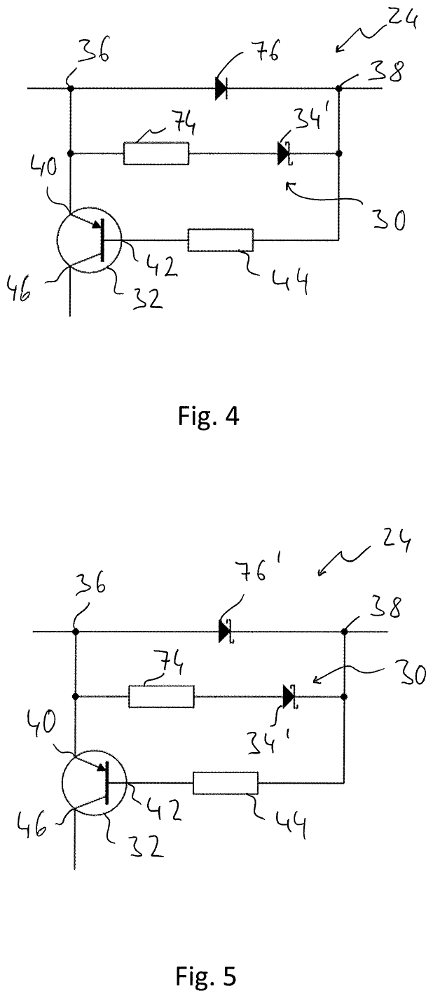

A further alternative embodiment of such a connection switch activation circuit 24 is shown in FIG. 4. In this embodiment, the reference diode 34′ is once again in the form of a Schottky diode and is connected in series with the resistor 74 between the input terminal 32 and the output terminal 38. A load diode 76, which is in the form of a p-n diode, is connected in parallel with the reference diode 34′. When the demand increases, the lower threshold voltage of the reference diode 34′ results in the latter initially transitioning into the conducting state thereof. Only when the current increases further does the load diode 76, which has a higher threshold voltage, also transition into the conducting state thereof, and therefore the larger part of the electrical current can then flow to the consumer V₁ via the load diode 76 and thus the reference diode 34′ is unloaded. Such an embodiment is advantageous, in particular, when, during a higher demand, the occurrence of pulsed currents, that is, temporary, comparatively high currents, is to be expected, which pulsed currents can then be conducted substantially across the load diode 76 before the associated connection switch transitions into the conducting state thereof.

In the embodiment shown in FIG. 5, both the reference diode 34′ and also the load diode 76′ are in the form of a Schottky diode.

It is to be pointed out that, in the various embodiments shown of such a connection switch activation circuit, the various electrical components thereof, in particular the various diodes, can also be sized depending on the closed-circuit current to be expected in conjunction with a particular consumer of electrical energy, or depending on the load current, which is optionally to be expected. In particular, in the embodiments shown in FIGS. 3 to 5, instead of the reference diodes 34′ in the form of Schottky diodes, it is also possible to use a germanium diode in each case. Germanium diodes have a threshold voltage that is approximately as low as that of Schottky diodes.

FIG. 7 shows an embodiment of a highly integrated safety circuit 52. The safety circuit 52 is connected using an input terminal 78 thereof or of a separator 82 to the direct current source 12, or to the positive pole thereof. An output terminal 80 of the safety circuit 52, or of the separator 82, is connected to the input terminals of the various connection switch activation circuits 24, 26, 28. The safety circuit 52 has, in the embodiment shown, a MOSFET as the separator 82, which MOSFET is or will be held in the conducting state thereof in order to establish or maintain a conducting connection between the input terminal 78 and the output terminal 80 and, as a result, to connect the direct current source 12 to the various consumers V₁, V₂, V₃ via the respective connection switch activation circuits 24, 26, 28 associated therewith.

The safety circuit 52 has a temperature sensor 84. The temperature signal of the temperature sensor, which represents the temperature in the region of the safety circuit 52, is entered into an overtemperature circuit 86. When a potentially critical temperature is exceeded, the overtemperature circuit 86 can output a corresponding activation signal to a gate control circuit 88, when then switches the switching element 82 into the non-conducting state thereof.

The safety circuit 52 can also include a current sensing circuit 90, which can sense the current flowing across the separator 82 and introduce a corresponding signal into an overcurrent circuit 92. If the electrical current flowing between the input terminal 78 and the output terminal 80 exceeds a predetermined threshold current, the overcurrent circuit 92 can supply a corresponding activation signal to the gate control circuit 88, and so the latter switches the separator 82, in the manner of a fuse, into the non-conducting state thereof. A signal indicating the amount of the electrical current can for example also be supplied to the connection switch activation unit 20. The latter in turn supplies, via a control terminal 94 of the safety circuit 52, a signal that switches the separator 82 into the open, non-conducting state thereof when a switch signal and, accordingly, an associated control signal, is generated by one of the connection switch activation circuits 24, 26, 28. In this manner, as described above, when a single switch signal, or control signal, occurs, all connection switch activation circuits 24, 26, 28 are disconnected from the direct current source 12, and the supply of the various consumers V₁, V₂, V₃ is ensured via the respective connection switches 14, 16, 18 associated therewith.

In order, in a state in which a defect resulting in a short circuit has possibly occurred in at least one of the consumers V₁, V₂, V₃, to prevent an excessively high current from flowing across the associated connection switch 14, 16, 18, which could also result in an overloading of the direct current source 12, each of the connection switches 14, 16, 18 can be configured in a way that is described above with reference to the safety circuit 52. This means that the connection switches 14, 16, 18 can also be configured such that they can act, in particular when excessively high currents occur, in the manner of a fuse and interrupt the current flow to a consumer when the current flow exceeds an associated threshold.

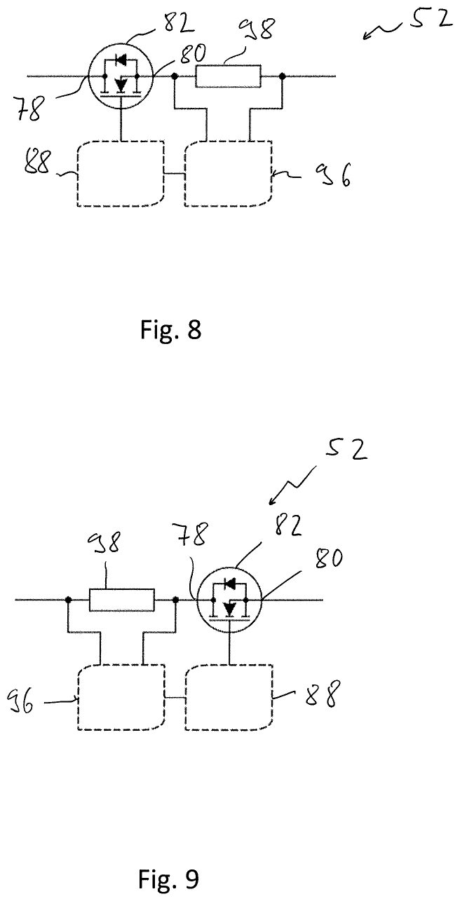

FIGS. 8 and 9 show further embodiment variants of such a safety circuit 52. The safety circuit 52 shown in FIG. 8 also includes a separator 82, which is in the form of a MOSFET, and a current sensing circuit, which is connected in series therewith and is designated in general with 96 and which, for example, has a resistor 98 connected in series with the separator 82. The current sensing circuit 98 can sense the current flow from the direct current source 12 to the connection switch activation circuits 24, 26, 28 and, if the current flow is excessively high or if a current threshold is exceeded, introduce a corresponding activation signal into the gate control circuit 88, which can then switch the separator 82 into the non-conducting state thereof. While, in the embodiment shown in FIG. 8, the current sensing circuit 96 is provided in the current flow direction downstream from the separator 82, that is, in connection with the output terminal 80 thereof, in the circuit shown in FIG. 9, the current sensing circuit 96 is positioned in the current flow direction upstream from the separator 82 and thus in connection with the input terminal 78 thereof, wherein, however, the same functionality is provided for sensing the electrical current flowing across the separator 82 to the connection switch activation circuits 24, 26, 28 and generating an activation signal for the gate control circuit 88 when current is excessively high.

It is understood that the foregoing description is that of the preferred embodiments of the invention and that various changes and modifications may be made thereto without departing from the spirit and scope of the invention as defined in the appended claims.

1-17. (canceled)

18. A connection circuit for connecting a plurality of consumers of electrical energy to a direct current source, the connection circuit comprising:
a plurality of connection switches associated with respective ones of said consumers for establishing a connection between the consumers and said direct current source;
one connection switch activation circuit associated with each one of said consumers for supplying a current thereto and for activating the connection switch thereof in order to establish the connection between the corresponding consumer and the direct current source;
wherein each one of the connection switch activation circuits includes a switching transistor, wherein a base-emitter voltage of the switching transistor depends on the current supplied to the associated consumer via the corresponding connection switch activation circuit; and,
wherein, when a base-emitter voltage at a collector terminal of the switching transistor exceeds a threshold voltage, a switch signal is generated for switching the associated connection switch into a closed state that establishes a connection between the associated consumer and the direct current source.

19. The connection circuit of claim 18, wherein the connection switch activation circuit includes a diode circuit having a reference diode; and, the base-emitter voltage of the switching transistor is related to a voltage drop at the reference diode in the diode circuit.

20. The connection circuit of claim 19, wherein the base-emitter voltage corresponds to a voltage drop at the reference diode.

21. The connection circuit of claim 20, wherein the reference diode is a p-n diode.

22. The connection circuit of claim 20, wherein the reference diode is a silicon diode.

23. The connection circuit of claim 19, wherein the diode circuit has at least one electrical resistor connected in series with the reference diode, and wherein the base-emitter voltage substantially corresponds to a voltage drop at the series connection of the reference diode and at least one electrical resistor.

24. The connection circuit as claimed in claim 23, wherein the reference diode is a Schottky diode or a germanium diode.

25. The connection circuit of claim 19, wherein the diode circuit has a load diode connected in parallel to the reference diode.

26. The connection circuit of claim 25, wherein a threshold voltage of the load diode is higher than a threshold voltage of the reference diode.

27. The connection circuit of claim 18, wherein the connection switch activation circuit has a control signal circuit; wherein the control signal circuit is configured to generate, when a switch signal has been generated at the collector terminal of the connection switch activation circuit, a control signal to be applied at the associated connection switch for switching the connection switch into the closed state thereof.

28. The connection switch of claim 18, wherein the connection switch activation circuit has an input terminal which is connected or is to be connected to the direct current source, and an output terminal which is connected or is to be connected to the associated consumer of electrical energy.

29. The connection circuit of claim 19, wherein the reference diode is connected in a forward direction between the input terminal and the output terminal.

30. The connection circuit of claim 28, wherein at least one of the following applies: i) an emitter terminal of the switching transistor is connected to the input terminal; and, ii) a base terminal of the switching transistor is connected to the output terminal.

31. The connection circuit of claim 28, wherein a safety circuit is provided, wherein the input terminals of all connection switch activation circuits are connected or are to be connected via a safety circuit to the direct current source; wherein the safety circuit is configured to monitor the current from the direct current source to all of the consumers; and, wherein the current exceeds a threshold current, to interrupt the connection between the direct current source and all of the consumers.

32. The connection circuit of claim 18, wherein a connection circuit activation unit is provided, wherein the connection circuit activation unit, when the switch signal is generated by at least one connection switch activation circuit associated with one consumer, performs at least one of the following:
i) deactivates all connection switch activation circuits;
ii) switches at least some of the connection switches into the closed state thereof; and,
iii) switches all of the connection switches into the closed state thereof.

33. The connection circuit of claim 31, wherein the connection switch activation unit is configured, in order to deactivate all connection switch activation circuits, to switch the safety circuit into an interrupt state interrupting the connection between the direct current source and all of the consumers.

34. The connection circuit of claim 18, wherein the switching transistor is a bipolar transistor.

35. The connection circuit of claim 18, wherein said connection circuit is in a vehicle.

36. An on-board electrical system for a vehicle, the on-board electrical system comprising:
a direct current source and consumers of electrical energy to be supplied with electrical energy from the direct current source; and,
a connection circuit for connecting a plurality of the consumers of electrical energy to the direct current source; the connection circuit including:
a plurality of connection switches associated with respective ones of said consumers for establishing a connection between the consumers and said direct current source;
one connection switch activation circuit associated with each one of said consumers for supplying a current thereto and for activating the connection switch thereof in order to establish the connection between the corresponding consumer and the direct current source;
wherein each one of the connection switch activation circuits includes a switching transistor, wherein a base-emitter voltage of the switching transistor depends on the current supplied to the associated consumer via the corresponding connection switch activation circuit; and,
wherein, when a base-emitter voltage at a collector terminal of the switching transistor exceeds a threshold voltage, a switch signal is generated for switching the associated connection switch into a closed state that establishes a connection between the associated consumer and the direct current source.
